(19) United States
(12) Patent Application Publication
(10) Pub. No.: US 2023/0130834 A1
(43) Pub. Date: Apr. 27, 2023

(54) METHODS OF MAKING AND USING A DENTAL APPLIANCE

(71) Applicant: VERASIL THERAPEUTICS RESEARCH INC., Langley (CA)

(72) Inventor: Andrew J.M. Willoughby, Langley (CA)

(21) Appl. No.: 17/908,125

(22) PCT Filed: Mar. 4, 2021
(86) PCT No.: PCT/US2021/020939

§ 371 Date: Aug. 30, 2022

Related U.S. Application Data
(60) Provisional application No. 62/985,272, filed on Mar. 4, 2020.

(51) Int. Cl. A61C 7/08; A61C 9/00; A61C 13/34

(52) U.S. Cl. CPC A61C 7/08; A61C 9/0006; A61C 13/34; A61C 9/0053

(57) ABSTRACT

Customized dental appliances are provided having a flexibly resilient shell with cavities shaped to embrace one or more teeth; wherein the shell is shaped so as to envelop at least the crown of the one or more teeth and at least a portion of the gingiva; and wherein the tooth-facing inner wall of said shell comprises one or more protrusions which press against the gingiva and/or one or more cavitation's which produce a pocket in the appliance.

### CROSS-REFERENCE TO RELATED APPLICATION

This application claims the benefit under 35 U.S.C. § 119(e) of U.S. Provisional Patent Application No. 62/985272, filed Mar. 4, 2020, which application is incorporated herein by reference in its entirety.

### FIELD OF THE INVENTION

The present invention relates generally to dentistry, and more specifically, to customizable dental appliances.

### BACKGROUND

Dental appliances, that is, devices that are inserted into the mouth and which encompass the teeth have been used for decades. Various types of dental appliances include devices to protect the teeth against injury (e.g., mouthguards), and appliances which are used in various dental procedures (e.g., orthodontic appliances such as the, Hawley retainer; vacuum formed retainers (commonly made from polypropylene or polyvinylchloride) and clear retainers/clear aligners such as INVISALIGN which are used to straighten teeth. Representative examples of such dental appliances can be found in U.S. Pat. Nos. 6,120,188, 6,398,548, 7,326,051, 7,357,637 and 8,356,993, as well as in FIG. 1.

Dental appliances can also be used to deliver a variety of substances to the teeth. For example, U.S. Publication No. 20090035714 discloses a system for repositioning teeth, which can also be used to deliver a desired substance (such as chlorhexidine).

One difficulty however with current dental appliances is that they cannot adequately deliver a desired substance directly to the gingiva over a prolonged period of time. The present invention overcomes many of the difficulties associated with currently available dental appliances, and further provides other related advantages.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

### SUMMARY

Briefly stated, the invention relates to dental appliances which have a flexibly resilient (e.g., polymer) shell with cavities shaped to embrace one or more teeth; wherein the shell is shaped so as to envelop at least the crown of the one or more teeth and at least a portion of the gingiva; and wherein the tooth-facing inner wall of said shell comprises one or more protrusions which press against the gingiva and/or one or more cavitation's which produce a pocket in the appliance.

Also provided are methods of making such dental appliances, and methods of using such dental appliances.

This Brief Summary has been provided to introduce certain concepts in a simplified form that are further described in detail below in the Detailed Description. Except where otherwise expressly stated, this Brief Summary is not intended to identify key or essential features of the claimed subject matter, nor is it intended to limit the scope of the claimed subject matter.

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary to employ concepts of the various patents, applications and publications as identified herein to provide yet further embodiments. Other features, objects and advantages will be apparent from the description, the drawings, and the claims.

### BRIEF DESCRIPTION OF THE DRAWINGS

Exemplary features of the present disclosure, its nature and various advantages will be apparent from the accompanying drawings and the following detailed description of various embodiments. Non-limiting and non-exhaustive embodiments are described with reference to the accompanying drawings, wherein like labels or reference numbers refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is representative illustration of a dental appliance of the prior art.

FIG. 2A is a representative illustration of a dental impression created within a dental tray.

FIG. 2B is a representative illustration of a dental casting.

FIG. 2C is a representative illustration of a dental casting with a groove or indentation formed in the gingival portion of the casting.

FIG. 2D is another representative illustration of a dental casting with a groove or indentation formed in the gingival portion of the casting.

FIG. 2E provides a representative illustration of a flexibly resilient shell being created on a dental casting.

FIG. 2F illustrates one embodiment of the trimming and preparation of a dental appliance.

FIG. 2G illustrates one representative dental appliance of the present invention.

FIG. 3A diagrammatically illustrates taking a three-dimensional dental image of a subject.

FIG. 3B illustrates a representative dental digital image, which has been digitally marked with dots or points.

FIG. 3C is another representative dental digital image from a different perspective than FIG. 3B, which depicts digital markings with dots or points.

FIG. 3D is a representative digital image with depicts the joining or connection of dots or points.

FIG. 3E is another representative digital image from a different perspective than FIG. 3D.

FIG. 3F is a representative digital image of a dental casting that shows an indentation in the gingiva of the digital image.

FIG. 4 is a representative illustration of a cross-section of a dental appliance.

FIG. 5 is a representative illustration of a cross section of a dental appliance having protrusions into the gingiva.

FIG. 6 is a representative illustration of a cross section of a dental appliance having protrusions into the gingiva, and a bump or protrusion from the teeth and a corresponding pocket in the dental appliance.

FIG. 7 provides a representative illustration of the loading of an agent into a dental appliance.

FIG. 8 provides a representative illustration of a dental appliance of the present invention placed onto a subject.

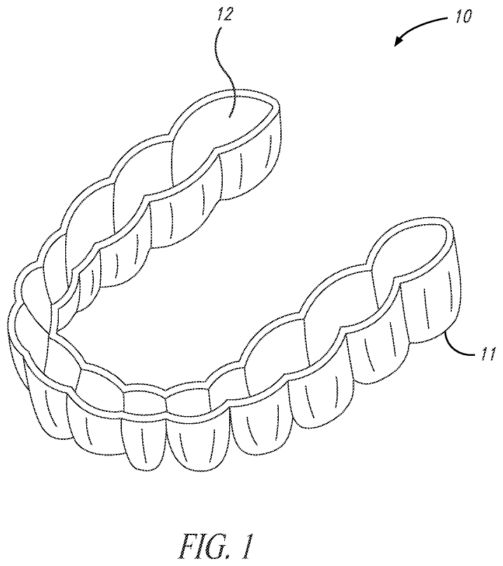

### DETAILED DESCRIPTION OF THE INVENTION

The present invention may be understood more readily by reference to the following detailed description of preferred embodiments of the invention and the Examples included herein. In order to further understanding thereof, the following definitions are provided (which are further discussed and described herein).

“Dental appliance” refers to a device that can be inserted into the mouth in order to protect and/or treat the teeth and/or gums. Various types of dental appliances include devices to protect the teeth against injury (e.g., mouthguards), and appliances which are used to in various dental procedures (e.g., orthodontic appliances such as the, Hawley retainer; vacuum formed retainers (commonly made from polypropylene or polyvinylchloride)and clear retainers/clear aligners such as INVISALIGN which are used to straighten teeth. Representative examples of dental appliances can be found in U.S. Pat. Nos. 6,120,188, 6,398,548, 7,326,051, 7,357,637 and 8,356,993.

“Agent” refers to a compound or composition which has an effect on a subject. The agent can be, for example, an antimicrobial agent (e.g., anti-bacterial or anti-fungal agent such as tetracycline or amphotericin); a wound-healing compound or composition; an anti-inflammatory agent; an agent which is used to protect (e.g., teeth or gingiva); or, an agent which is used to cosmetically change the appearance of teeth (e.g., a whitening agent).

“Silver” as used herein refers to the metal silver (or “Ag”), which may be in any of a number of different forms (e.g., particles including particles with neutral silver metal, ions and salts, and mixtures thereof). The terms “colloidal silver”, “particulate silver” and “silver particles” are used interchangeably to refer to discrete particles that comprise silver. In one embodiment, colloidal silver refers to particles which in whole or in part comprise silver, where the particles are suspended in an aqueous medium. Representative examples of silver as utilized herein includes colloidal silver having a coating of silver oxide, e.g., Ag₂O or Ag₄O₄). Representative patents which disclose silver compounds suitable for use within the present invention are described in and may be prepared by techniques disclosed in U.S. Pat. Nos. 6,214,299; 6,743,348; 7,135,195; and 8,535,728 as well as U.S Publication Nos. 2011/0262556 and 2018/0235232 (all of which are incorporated by reference in their entirety).

The terms “treat” or “treating” or “treatment,” as used herein, means an approach for obtaining beneficial or desired results, including clinical results. Beneficial or desired clinical results can include, but are not limited to, reducing the incidence of a disease, alleviation or amelioration of one or more symptoms or conditions, diminishment of extent of disease, stabilized (i.e. not worsening) state of disease, preventing the incidence of or spread of disease (e.g., in the case of a vaccine), delay or slowing of disease progression, amelioration or palliation of the disease state, diminishment of the reoccurrence of disease, and remission (whether partial or total), whether detectable or undetectable.

### REPRESENTATIVE EMBODIMENTS OF THE INVENTION

In order to further understand various aspects of the invention provided herein, the following sections are provided below: A. Methods of Making Dental Appliances; B. Methods of Using Dental Appliances; and C. Compositions and Methods for Cleaning Medical Instruments.

A. Methods of Making Dental Appliances

As noted above, the present invention provides a variety of methods for making dental appliances, which are, in preferred embodiments, customized to an individual subject.

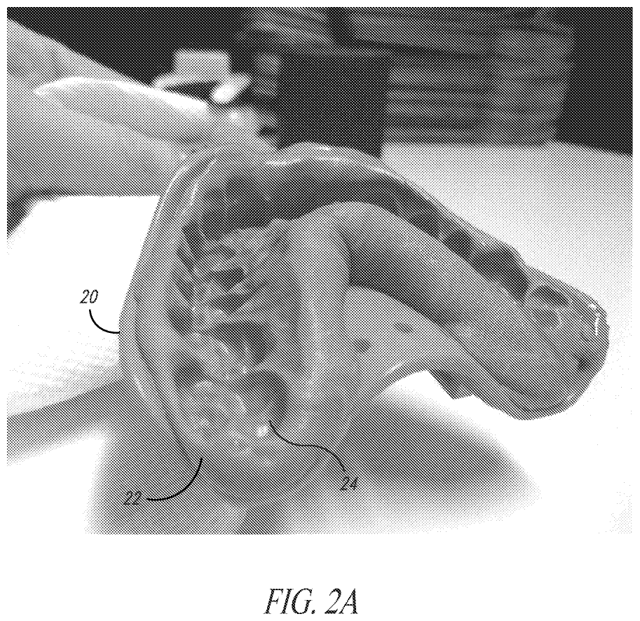

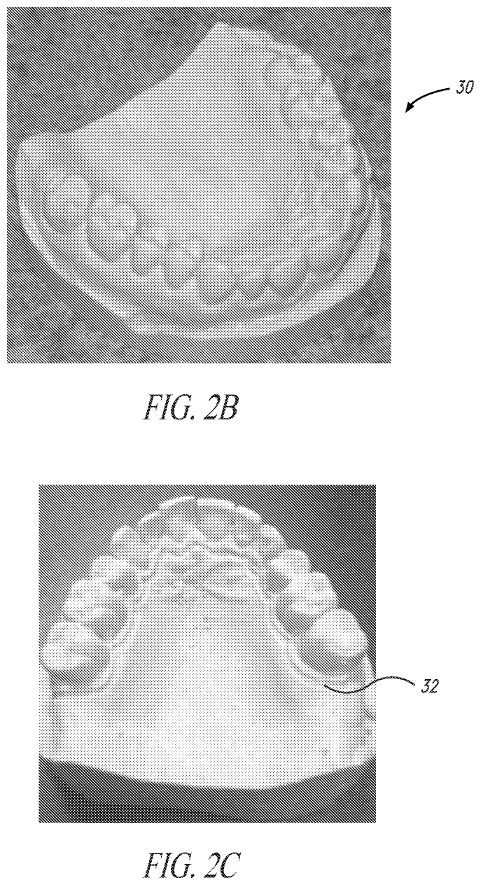

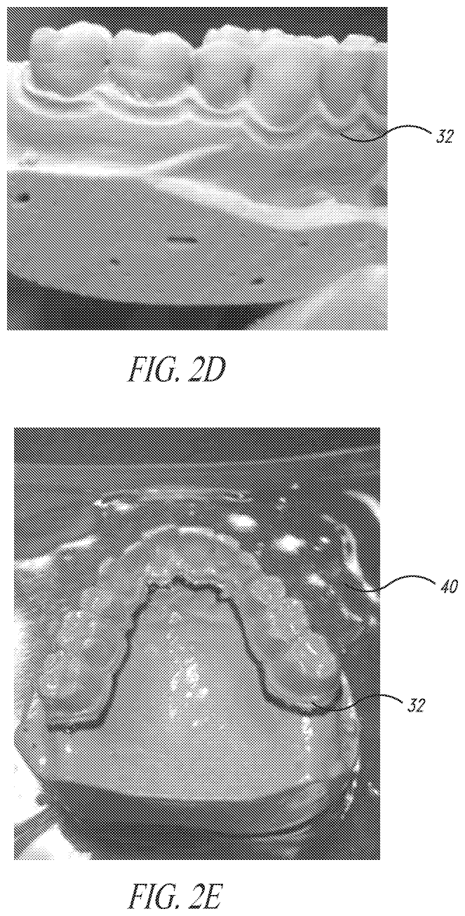

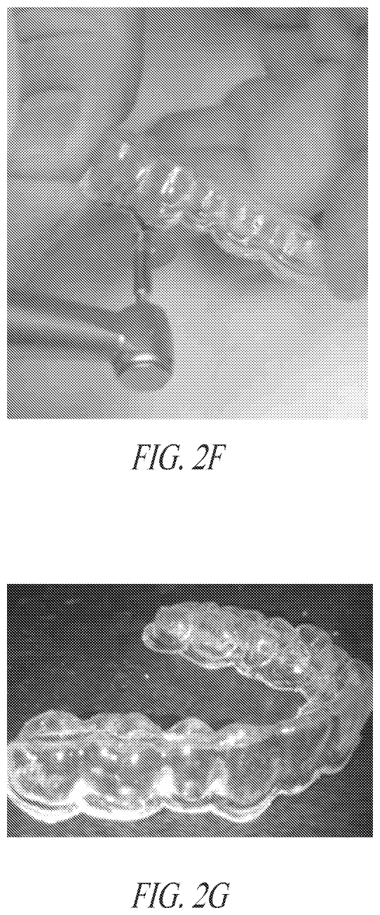

For example, as shown in FIG. 2A, a dental impression 24 showing individual teeth 24 can be created in a tray 20 using commonly available compositions such as ALIGNOT and Vinyl Polysiloxane (or “VPS”). This impression can be used to create a dental cast 30 as shown in FIG. 2B. Within certain embodiments of the invention, the dental casting can be modified by creating one or more indentations or grooves into the gingival portion of the cast (See 32 in FIGS. 2C and 2D). A dental appliance can then be created by forming a flexibly resilient shell 40 onto the dental cast having an indentation or grove 32.

The resultant dental appliance can be trimmed as necessary (see FIG. 2F) to produce a complete dental appliance (FIG. 2G).

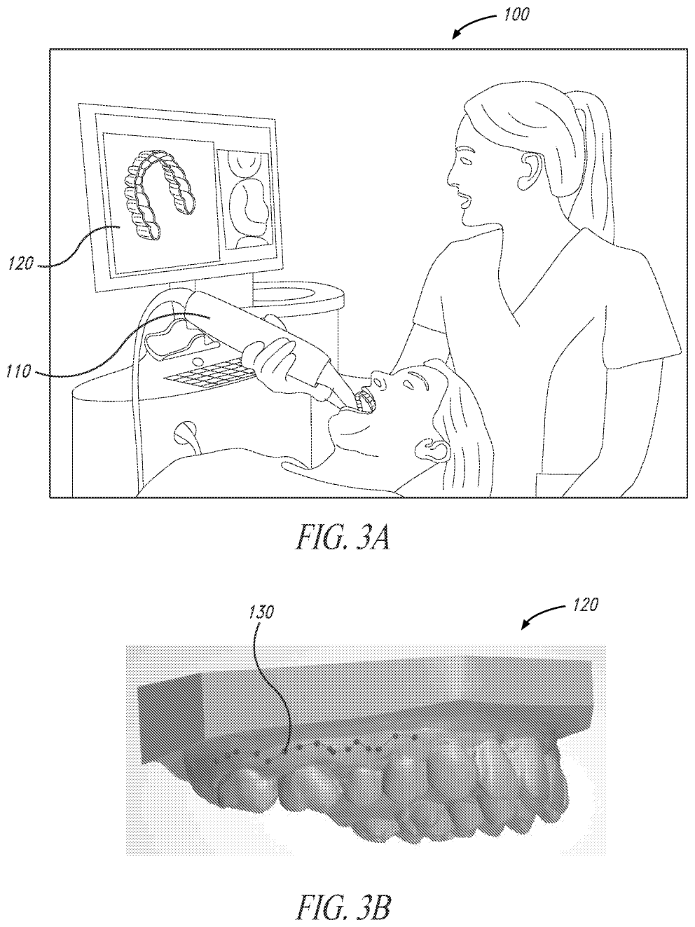

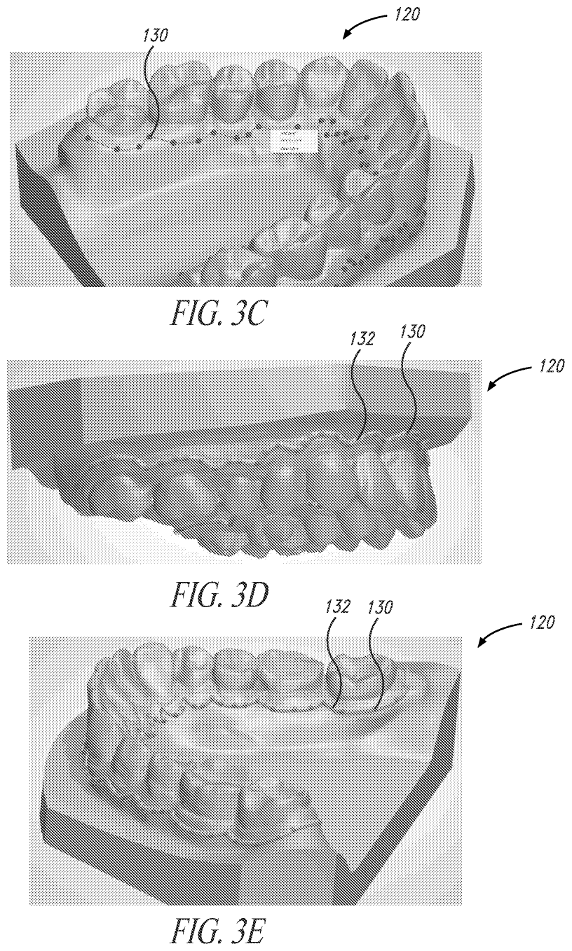

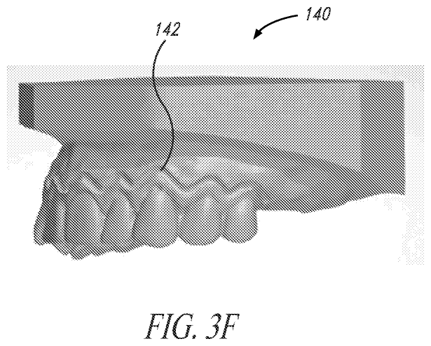

Within other aspects of the invention the dental appliances as described herein can be made using all (or partly) digital techniques. For example, within one embodiment of the invention a three-dimensional dental image is taken of a subject as shown in FIG. 3A, using a scanner 110 to produce a digital image 120. Representative examples of instruments which create three-dimensional dental images include TRIOS, iTERO, PRIMESCAN, AND CARESTREAM.

One exemplary embodiment of a digital image is shown in FIG. 3B. As is further shown in FIG. 3B, one or more markings or dot's 130 may be digitally placed on the digital image (see FIGS. 3B and 3C) using a program such as CAD and linking of the one or more marks or dots 130 into a contiguous line 132 as shown in FIGS. 3D and 3E. This digital image can be used to create a negative image 3F for a dental appliance. For example, within one embodiment the negative image 3F can be used to make a dental casting similar to that provided in FIGS. 2C and 2D. This casting can then be used to make a dental appliance as shown in FIGS. 2E through 2G.

Alternatively, the digital image provided in FIG. 3F can be utilized to directly three-dimensionally print a dental appliance using, for example, a 3D printer.

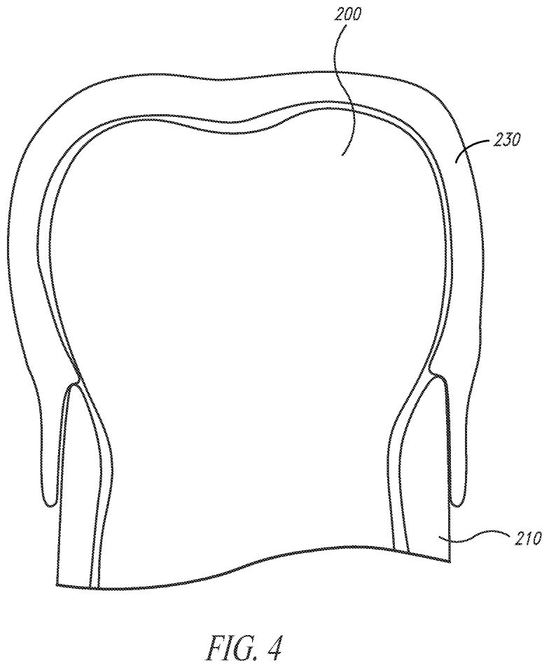

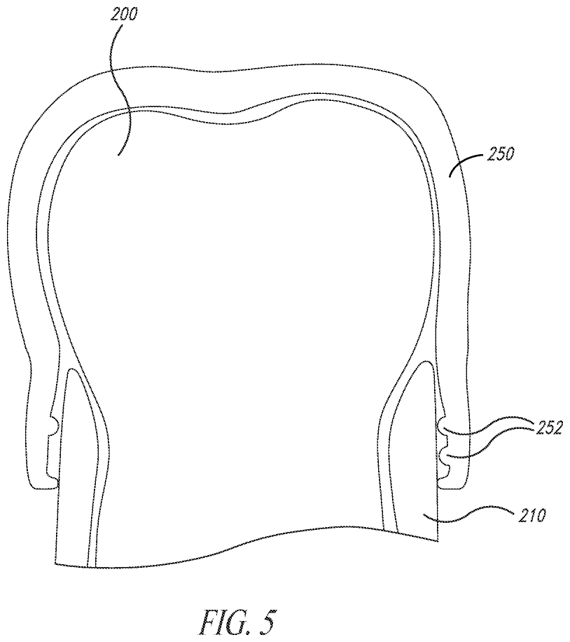

A wide variety of dental appliances can be created using the methods provided herein. For example, FIG. 4 presents a cross-sectional image of a dental appliance 230 on a tooth 200 without any protrusions, pockets, or deformations other than to match the contours of a tooth 200 and part of the gingiva 210.

FIG. 5 presents another cross-sectional image of a dental appliance 250 on a tooth 200 with protrusions, projections or out-pocketing's 252 which press into or abut the gingiva 210. Within certain embodiments multiple (e.g., 2, 3, or more) protrusions may be created. Within preferred embodiments of the invention the one or more protrusions run contiguously along the gingiva of one or more teeth. This creates a protruding line or outcropping against the gingiva.

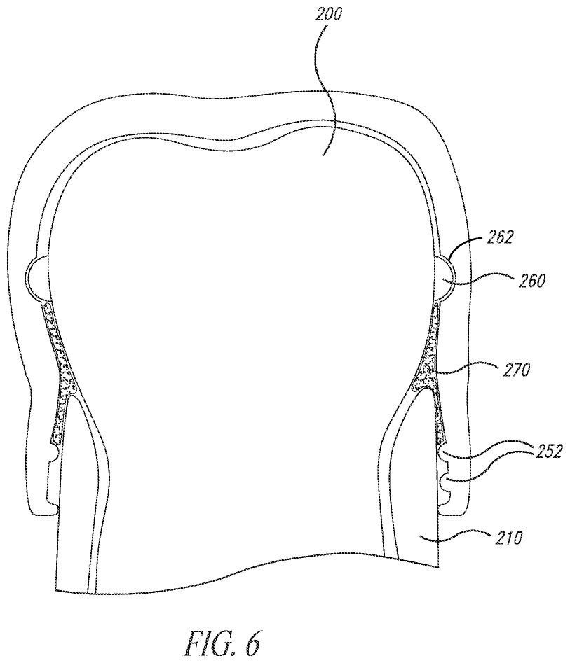

Within yet other embodiments, as shown in FIG. 6 one or more bump(s) or retention point(s) 262 can be created on one or more teeth. Using the techniques and methods described herein a dental appliance can be constructed wherein a retention point 262 matches a pocket 260 within the dental appliance. This system can be used to help retain the dental appliance in place. Within various embodiments, the dental appliance can have 1, 2, 3, 4, 5, 6, 7, 8, 9, 10, 11, 12, 13, 14, 15, 16, or more (generally less than 32) cavitation's or pockets. These cavitation's or pockets can be used to anchor the dental appliance in place, along with a corresponding bump or retention point (e.g., artificially created) on the one or more teeth. Within certain embodiments of the invention, the cavitation's or pockets can be interrupted or discrete (e.g., since they are on the teeth they may not run contiguously in a line along the dental appliance.

The dental appliance illustrated in FIG. 6 can also have protrusions 252 against the gingiva, which can assist in retaining one or more agents 270 against or in contact with the gingiva and the gingival pocket.

B. Methods of Using Dental Appliances

The dental appliances of the present invention can be used in a wide variety of treatments and therapies, including for example: 1) for treatment of periodontal disease; 2) after periodontal surgery; and 3) to assist in orthodontic methods.

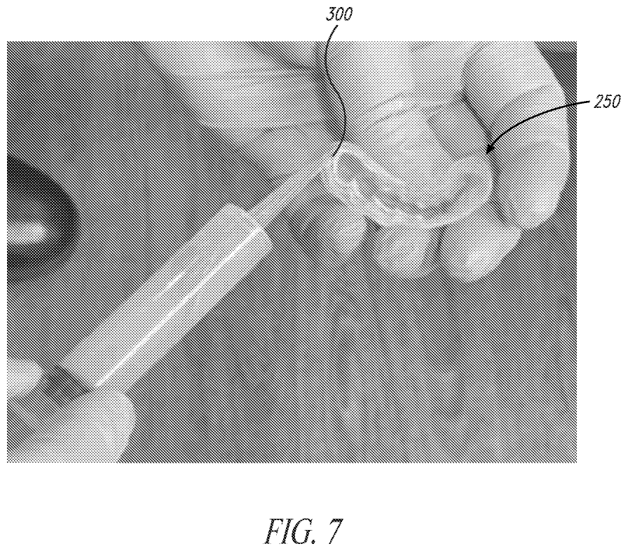

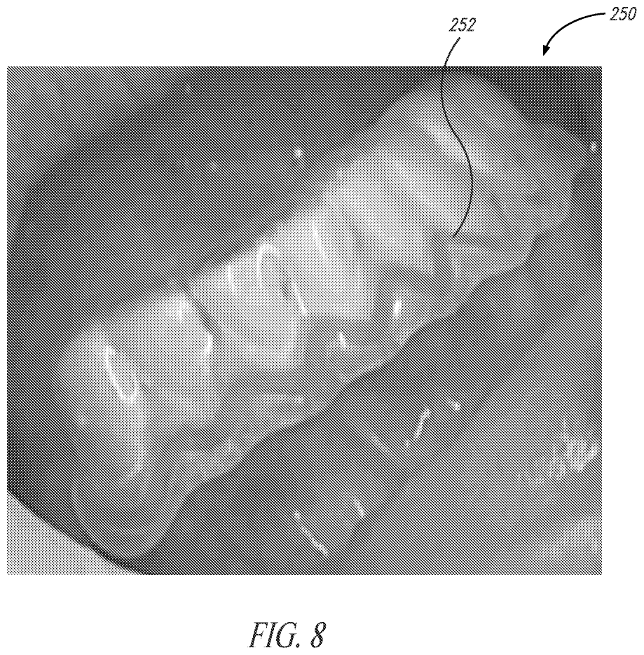

As an example, one or more agents can be applied to the dental appliance as shown in FIG. 7 and applied to a subject as illustrated in FIG. 8. A wide variety of agents can be delivered using the dental appliances provided herein (and as shown in FIG. 7). Representative examples include antibiotics such as clindamycin, tetracycline, doxycycline, erythromycin, amoxicillin, penicillin, vancomycin and minocycline. Other representative agents include Potassium Persulfate and EDTA. Other representative agents include antiseptics (e.g., iodine, hydrogen peroxide). Other antiseptics such as Chlorhexidine (marketed as PERIDEX, PERIODEX, PERIOCHIP, and PERIOGARD amongst others) can also be used but are generally not as preferred.

Other agents that can also be applied in various combinations include one or more of: 20-100 ppm silver as described herein and/or one or more oxidizers (e.g., Potassium Persulfate or “KPS); 0.1-25% Ethylenediaminetetraacetic acid (“EDTA”); 0.5-10% iodine (e.g., Povidone Iodine); and 0.1-5% Hydrogen Peroxide).

Agents (e.g., antibiotics and/or bleaching agents such as Potassium Persulfate) can also be delivered into the coronal side of the dental appliance.

Particularly preferred agents for use in the dental appliances provided herein are silver based compositions. As noted above, “silver” as used herein refers to the metal silver (or “Ag”), which may be in any of a number of different forms (e.g., particles including particles with neutral silver metal, ions and salts, and mixtures thereof). The terms “colloidal silver”, “particulate silver” and “silver particles” are used interchangeably to refer to discrete particles that comprise silver. In one embodiment, colloidal silver refers to particles which in whole or in part comprise silver, where the particles are suspended in an aqueous medium. Representative examples of silver as utilized herein includes colloidal silver having a coating of silver oxide, e.g., Ag₂O or Ag₄O₄).

In one aspect of the invention the total amount of colloidal silver in a composition may be between 1 ppm and 100 ppm. In optional embodiments, the content of colloidal silver in the composition is about 30±5 ppm, or 25±5 ppm, or 20±5 ppm, or 15±5 ppm, or 10±5 ppm. As the particles become smaller, a given concentration of particles will represent a larger number of particles.

In one embodiment, a composition of the present disclosure contains silver particles comprising silver in the +2 oxidation state, the particles being present in the composition within a stated concentration range having a minimum and maximum concentration, where the minimum concentration is selected from 0.01 ppm, or 0.02 ppm, or 0.03 ppm, or 0.04 ppm, or 0.05 ppm, or 0.06 ppm, or 0.07 ppm, or 0.08 ppm, or 0.09 ppm, or 0.1 ppm, or 0.2 ppm, or 0.3 ppm, or 0.4 ppm, or 0.5 ppm, or 0.6 ppm, or 0.7 ppm, or 0.8 ppm, or 0.9 ppm, or 1 ppm, or 2 ppm, or 3 ppm, or 4 ppm, or 5 ppm, or 6 ppm, or 7 ppm, or 8ppm, or 9 ppm, or 10 ppm, and the maximum concentration is selected from 1,000 ppm, or 500 ppm, or 400 ppm, or 300 ppm, or 200 ppm, or 100 ppm, or 90 ppm, or 80 ppm, or 70 ppm, or 60 ppm, 50 ppm, or 40 ppm, or 30 ppm, or 25 ppm, or 20 ppm, or 15 ppm, or 10 ppm, where ppm has its standard meaning and refers to parts per million, i.e., weight parts of silver particles per one million weight parts of the composition, e.g., 10 ppm refers to 10 grams of silver particles per every 1 million grams of composition. Exemplary silver particle concentrations of 1-100 ppm, or 0.5-500 ppm, or 0.1-1,000 ppm, or less than 20 ppm, or less than 50 ppm, or 10-35 ppm are provided by the present invention, as well as concentrations within 1-100 ppm as mentioned previously. A benefit of using silver (II) at low concentration includes providing a product with a longer shelf life, e.g., providing a product that retains the desired performance benefit for a longer period of time, or providing a product that retains its consistency for a longer period of time, or providing a product that retains its original color for a longer period of time, since unwanted oxidation reactions that can shorten shelf life and/or damage the consistency of the product, and/or cause discoloration, are reduced.

Representative patents which disclose silver compounds suitable for use within the present invention are described in, and may be prepared by techniques disclosed in U.S. Pat. Nos. 6,214,299; 6,743,348; 7,135,195; and 8,535,728 as well as U.S Publication Nos. 2011/0262556 and 2018/0235232 (all of which are incorporated by reference in their entirety).

C. Compositions and Methods for Cleaning Medical Instruments.

Within other aspects of the invention compositions and methods are provided for cleaning medical instruments

Within one aspect of the invention the cleaning compositions comprise silver, as described herein, along with one or more medical grade enzymes (e.g., protease, lipase and/or amylase). Within preferred embodiment the cleaning compositions comprises colloidal silver having a coating of silver oxide (e.g., Ag₂O or Ag₄O₄), at a concentration of about 10 to about 60 ppm, and medical grade enzymes (e.g., protease, lipase and/or amylase) Within other embodiments the cleaning solution may further comprise one or more of: 20-100 ppm of one or more oxidizers (e.g., Potassium Persulfate or “KPS”); 0.1-25% Ethylenediaminetetraacetic acid (“EDTA”); 0.5-10% iodine (e.g., Povidone Iodine); and/or 0.1-5% Hydrogen Peroxide.

The cleaning solutions provided herein may be used to clean a wide variety of medical instruments, including for example, dental instruments, as well as other medical instruments that are used (and reused after cleaning) on patients. Representative examples include endoscopes and laparoscopes.

Within various embodiments of the invention, the cleaning solutions provided herein can be used to clean (suitable for reuse in a subject) a medical instrument such as a dental instrument, endoscope, or, laparoscope. Representative patents and patent applications which describe suitable machines and methods are described in U.S. Pat. Nos. 8,840,733 and 9,204,936, and in United States Patent Application Nos. 2010/0252074, 2011/0097248 and 2017/0296046, which are hereby incorporated by reference in their entirety.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

The following are some exemplary numbered embodiments of the present disclosure.
1. A dental appliance, comprising: a flexibly resilient shell having cavities shaped to embrace one or more teeth; wherein said shell is shaped so as to envelop at least the crown of said one or more teeth and at least a portion of the gingiva; and wherein the tooth-facing inner wall of said shell comprises one or more thickened section or protrusions which press against the gingiva and/or one or more cavitation's which produce a pocket in the appliance (e.g., suitable for assisting retention of the dental appliance in the mouth by, for example, anchoring to a protrusion placed on one or more teeth by a dental practitioner).—Within preferred embodiments the one or more protrusions is 1, 2, or, 3 protrusions. Within related embodiments when the dental appliance is placed on a subject's teeth, the one or more protrusions press against the gingiva to create a pocket above the protrusion (toward the coronal top of the device). Similarly, the appliance can have 1, 2, 3, 4, 5, 6, 7, 8, 9, 10, 11, 12, 13, 14, 15, 16, or more (generally less than 32) cavitation's or pockets. These cavitation's or pockets can be used to anchor the dental appliance in place, along with a corresponding bump (e.g., artificially created) on the one or more teeth. Within certain embodiments of the invention, the protrusions are contiguous along the gingiva, whereas the cavitation's or pockets can be interrupted or discrete.

Within other aspects of the invention the dental appliance is as described in any one of U.S. Pat. Nos. 6,120,188, 6,398,548, 6,966,773, 7,326,051, 7,357,637 or 8,356,993, or PCT US 2009/0035714 or 2014/02771499, all of which are incorporated by reference in their entirety.
2. The dental appliance according to embodiment 1, wherein said flexibly resilient shell is comprised of a polymer.
3. The dental appliance according to embodiments 1 or 2, wherein said appliance covers the entire upper, or, lower set of teeth. Within other embodiments the appliance only covers a portion of the upper or lower teeth.
4. The dental appliance according to embodiments 1, 2 or 3 wherein said protrusion comprises at least two protrusions.
5. A system, comprising the dental appliance according to any of embodiments 1, 2, 3 or 4, further comprising an agent loaded into said dental appliance. Within preferred embodiments the agent is an anti-microbial (e.g., anti-bacterial and/or anti-fungal agent). Representative anti-microbial agents include tetracycline and amphotericin.
6. The system according to embodiment 5, wherein said agent is a wound healing agent. Within preferred embodiments the agent is silver, or, a silver containing composition.
7. A system, comprising the dental appliance according to any of embodiments 1, 2, 3, or 4, further comprising an anti-inflammatory agent loaded into said dental appliance.
8. A method for creating a customized dental appliance, comprising:
   (a) taking a dental impression of a subject;
   (b) creating a dental casting from said impression;
   (c) creating an indention beneath the gingiva/tooth interface in said dental casting;
   (d) creating a flexibly resilient shell on said dental casting; and
   (e) removing said flexibly-resilient shell from said casting.
9. The method according to embodiment 8 wherein said dental impression is taken using ALIGNOT or Vinyl Polysiloxane. Other representative examples of impression forming compositions include reversible hydrocolloids such as agar, irreversible hydrocolloids such as sodium alginate, elastomeric materials (e.g., silicone, polyethers and polysulfides), and (although less preferred), rigid materials such as Plaster of Paris.
10. The method according to embodiment 8 wherein dental impression is taken using with a 3D digital dental scanner (to create a three-dimensional digital image). Within further embodiments, the three dimensional digital image is in a Digital Imaging and Communications in Medicine or “DICOM” format. Within yet further embodiments of the invention, the digital image may be manipulated (e.g., by Computer Aided Design or “CAD”) in order to produce a different image (e.g., an image of a dental appliance with protrusion or cavitation's discussed herein).
11. The method according to embodiment 10 wherein a dental casting is created with a 3D printer.
12. A method for creating a customized dental appliance, comprising:
   (a) taking a three-dimensional dental image of a subject; and
   (b) forming a customized dental appliance based upon said three-dimensional dental image. Within certain embodiments, the dental appliance is constructed using a 3D printer.
13. The method according to embodiment 12, wherein said customized dental appliance is an appliance according to any one of embodiments 1, 2, 3, or 4.
14. A method for treating periodontal disease, comprising applying a dental appliance according to any one of embodiments 1, 2, 3, 4, or, a system according to any one of embodiments 5, 6, or, 7 to a subject.
15. The method according to embodiment 14, further comprising, prior to the step of applying said dental appliance, debriding the teeth of calculus and/or biofilm.
16. A method of treating periodontal disease, comprising applying a system according to any one of embodiments 5, 6, or, 7 to a subject.
17. A method of modifying tooth position, comprising applying a dental appliance according to embodiments 1, 2, 3, or, 4, or, a system according to embodiments 5, 6, or, 7 to a subject.
18. The method of embodiment 17, further comprising, prior to the step of applying a dental appliance, cleaning the teeth and/or performing dental surgery on periodontal pockets. Within certain embodiments of the invention Laser Bacterial Reduction (“LBR”) and/or Laser Debridement Therapy (“LDT”) is accomplished using, for example, a Erbium, Odyssey Red Tissue Diode Laser, or, a Waterlase style laser.
19. A composition, comprising silver, and one or more enzyme.
20. The composition according to embodiment 19, wherein said silver is a colloidal silver having a coating of silver oxide.
21. The composition according to embodiment 19 wherein said silver oxide is Ag₂O or Ag₄O₄.
22. The composition according to any one of embodiments 19-21 wherein said one or more enzyme is a protease, lipase and/or amylase. Within preferred embodiments of the invention the enzyme is a medical-grade enzyme (e.g., sterile and/or approved for use in cleaning medical instruments).
23. The composition according to any one of embodiments 19-22, further comprising 20-100 ppm of one or more oxidizers such as Potassium Persulfate.
24. The composition according to any one of embodiments 19-23, further comprising 0.1-25% Ethylenediaminetetraacetic acid.
25. The composition according to any one of embodiments 19-24, further comprising 0.5-10% iodine, such as Povidone Iodine.
26. The composition according to any one of embodiments 19-25, further comprising 0.1-5% Hydrogen Peroxide.
27. The composition according to any one of embodiments 19-26, wherein said composition is sterile.
28. The composition according to any one of embodiments 19-27, wherein said composition does not contain chlorhexidine.
29. The composition according to any one of embodiments 19-28, further comprising an anti-microbial agent.
30. The composition according to embodiment 29, wherein said antimicrobial agent is clindamycin, tetracycline, doxycycline, erythromycin, amoxicillin, penicillin, vancomycin or minocylcine
31. Use of a composition according to any one of embodiments 19 -30, for cleaning a medical instrument.
32. A method of cleaning a medical instrument, comprising applying a composition according to any one of embodiments 19 to 30 to a medical instrument.
33. The method of embodiment 32, wherein said medical instrument is a dental instrument, an endoscope, or, a laparoscope.
34. The method of embodiment 32 or 33, further comprising one or more of the following steps: (a) using a mechanical cleaner on one or more medical instruments which are in the presence of a composition according to any one of embodiments 19 to 28; (b) using an ultrasonic cleaner on one or more medical instruments which are in the presence of a composition according to any one of embodiments 19 to 28.
35. The method of embodiment 34, further comprising, subsequent to the one or more steps cited in embodiment 34, rinsing, steaming, and/or sterilizing said medical instrument.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended, and those skilled in the art will recognize, that the invention embraces and is also thereby described in terms of any individual member and any subgroup of members of the Markush group, and Applicants reserve the right to revise the application or claims to refer specifically to any individual member or any subgroup of members of the Markush group.

It is to be understood that the terminology used herein is for the purpose of describing specific embodiments only and is not intended to be limiting. It is further to be understood that unless specifically defined herein, the terminology used herein is to be given its traditional meaning as known in the relevant art.

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents, i.e., one or more, unless the content and context clearly dictates otherwise. For example, the term “a protrusion” refers to one or more protrusions. It should also be noted that the conjunctive terms, “and” and “or” are generally employed in the broadest sense to include “and/or” unless the content and context clearly dictates inclusivity or exclusivity as the case may be. Thus, the use of the alternative (e.g., “or”) should be understood to mean either one, both, or any combination thereof of the alternatives. In addition, the composition of “and” and “or” when recited herein as “and/or” is intended to encompass an embodiment that includes all of the associated items or ideas and one or more other alternative embodiments that include fewer than all of the associated items or ideas.

Unless the context requires otherwise, throughout the specification and claims that follow, the word “comprise” and synonyms and variants thereof such as “have” and “include”, as well as variations thereof such as “comprises” and “comprising” are to be construed in an open, inclusive sense, e.g., “including, but not limited to.” The term “consisting essentially of” limits the scope of a claim to the specified materials or steps, or to those that do not materially affect the basic and novel characteristics of the claimed invention.

Any headings used within this document are only being utilized to expedite its review by the reader, and should not be construed as limiting the invention or claims in any manner. Thus, the headings and Abstract of the Disclosure provided herein are for convenience only and do not interpret the scope or meaning of the embodiments.

Where a range of values is provided herein, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

For example, any concentration range, percentage range, ratio range, or integer range provided herein is to be understood to include the value of any integer within the recited range and, when appropriate, fractions thereof (such as one tenth and one hundredth of an integer), unless otherwise indicated. Also, any number range recited herein relating to any physical feature, such as polymer subunits, size or thickness, are to be understood to include any integer within the recited range, unless otherwise indicated. As used herein, the term “about” means±20% of the indicated range, value, or structure, unless otherwise indicated.

All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Such documents may be incorporated by reference for the purpose of describing and disclosing, for example, materials and methodologies described in the publications, which might be used in connection with the presently described invention. The publications discussed above and throughout the text are provided solely for their disclosure prior to the filing date of the present application. Nothing herein is to be construed as an admission that the inventors are not entitled to antedate any referenced publication by virtue of prior invention.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

Furthermore, the written description portion of this patent includes all claims. Furthermore, all claims, including all original claims as well as all claims from any and all priority documents, are hereby incorporated by reference in their entirety into the written description portion of the specification, and Applicants reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

Other nonlimiting embodiments are within the following claims. The patent may not be interpreted to be limited to the specific examples or nonlimiting embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

1. A dental appliance, comprising: a flexibly resilient shell having cavities shaped to embrace one or more teeth; wherein said shell is shaped so as to envelop at least the crown of said one or more teeth and at least a portion of the gingiva; and wherein the tooth-facing inner wall of said shell comprises one or more protrusions which press against the gingiva and/or one or more cavitation's which produce a pocket in the appliance.

2. The dental appliance according to claim 1, wherein said flexibly resilient shell is comprised of a polymer.

3. The dental appliance according to claim 1, wherein said appliance covers the entire upper, or, lower set of teeth.

4. The dental appliance according to claim 1 wherein said protrusion comprises at least two protrusions.

5. A system, comprising the dental appliance according to claim 1, further comprising an anti-microbial agent loaded into said dental appliance.

6. The system according to claim 5, wherein said anti-microbial agent comprises silver.

7. A system, comprising the dental appliance according to claim 1, further comprising an anti-inflammatory agent loaded into said dental appliance.

8. A method for creating a customized dental appliance, comprising:
(a) taking a dental impression of a subject;
(b) creating a dental casting from said impression;
(c) creating an indention beneath the gingiva/tooth interface in said dental casting;
(d) creating a flexibly resilient shell on said dental casting; and
(e) removing said flexibly-resilient shell from said casting.

9. The method according to claim 8 wherein said dental impression is taken using ALIGNOT or Vinyl Polysiloxane.

10. The method according to claim 8 wherein dental impression is taken using with a 3D digital dental scanner.

11. The method according to claim 10 wherein said dental casting is created with a 3D printer.

12. A method for creating a customized dental appliance, comprising:
(a) taking a three-dimensional dental image of a subject; and
(b) forming a customized dental appliance based upon said three-dimensional dental image.

13. The method according to claim 12, wherein said customized dental appliance is an appliance according to claim 1.

14. A method for treating periodontal disease, comprising applying a dental appliance according to claim 1 to a subject.

15. The method according to claim 14, further comprising, prior to the step of applying said dental appliance, debriding the teeth of calculus and/or biofilm.

16. A method of treating periodontal disease, comprising applying a system according to claim 5 to a subject.

17. A method of modifying tooth position, comprising applying a dental appliance according to claim 1 or a system according to claim 5 to a subject.

18. The method of claim 17, further comprising, prior to the step of applying a dental appliance, cleaning the teeth and/or performing dental surgery on periodontal pockets.
